(19) United States
(12) Patent Application Publication
(10) Pub. No.: US 2013/0025149 A1
(43) Pub. Date: Jan. 31, 2013

(54) Body Dryer

(71) Applicant: Tarek Farousi, Agawam, MA (US)

(72) Inventor: Tarek Farousi, Agawam, MA (US)

(21) Appl. No.: 13/192,551

(22) Filed: Jul. 28, 2011

(51) Int. Cl. F26B 25/06; F26B 19/00

(52) U.S. Cl. 34/88; 34/227

(57) ABSTRACT

A walk through forced air body dryer is provided. The body has a housing that provides a walk through passage, a blower, and an aperture or apertures to direct air towards an inside of the passage.

### BACKGROUND OF THE INVENTION

1. Field of the Invention

The present invention relates generally to forced air drying systems. More particularly, the present invention relates to a walk-through forced air body dryer.

2. Description of Related Art

Drying of the body after showering, bathing, swimming, and the like is typically performed using a towel, as is well known. However, towels suffer a number of shortcomings. Some such shortcomings include sanitary issues, a need to wash towels frequently, the towels being rough on the skin, being difficult to use to thoroughly dry all areas of the body, and being cumbersome to those who may be injured, disabled, or elderly.

Therefore, what is needed is a device that may efficiently and easily dry a person's body without the use of a towel.

### SUMMARY OF THE INVENTION

The subject matter of this application may involve, in some cases, interrelated products, alternative solutions to a particular problem, and/or a plurality of different uses of a single system or article.

In one aspect, a body dryer is provided. The body dryer having a top, two sides, and forming a passageway through which a user may pass, an aperture formed by a housing to direct a quantity of air into the passageway, and a blower in fluid communication with the aperture, the blower constructed and arranged to provide the quantity of air directed into the passageway by the aperture.

In another aspect, a body drying apparatus for outdoor use is provided. The body drying apparatus having a housing having a top, two sides, and forming a passageway through which a user may pass, the housing being positioned substantially in proximity to a swimming pool, the housing being configured to be weather resistant for outdoor use, an aperture formed by the housing to direct a quantity of air into the passageway, and a blower, in fluid communication with the aperture, the blower constructed and arranged to provide the quantity of air directed into the passageway by the aperture, the blower being sized to provide a sufficient flow of air such that a human body may be substantially dried after being in the swimming pool.

In yet another aspect, a body drying apparatus for indoor use is provided. The body drying apparatus having a housing having a top, two sides, and forming a passageway through which a user may pass, the housing being positioned substantially in proximity to a shower or bathtub, an aperture formed by the housing to direct a quantity of air into the passageway, and a blower, in fluid communication with the aperture, the blower constructed and arranged to provide the quantity of air directed into the passageway by the aperture, the blower being sized to provide a sufficient flow of air such that a human body may be substantially dried after being in the swimming pool.

### BRIEF DESCRIPTION OF THE DRAWINGS

FIG. 1 provides a front cutaway view of one embodiment of the body dryer.

FIG. 2 provides a perspective partial cutaway view of one embodiment of the body dryer.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a walk-through body dryer. This walk-through body dryer may have a housing, an air blower, and a plurality of air outlet apertures on the housing. The body dryer may serve to substantially dry a user's body when wet, after for example, bathing, swimming, sweating and the like. The term “substantially dry” is contemplated herein to mean that a user's body will be mostly, if not entirely dry, and at least means that a user's body is not dripping wet.

The walk through body dryer may have a housing that provides structure for the dryer. The housing may have a top and two sides, each side being joined to the top at opposite ends of the top. This construction may form an open passageway formed by the top and two sides. In one embodiment, this construction may form an inverted ‘u’ shape.

The passageway formed by the housing may be sized to allow an averaged size user to walk through it in a fully upright position. The user may pause when within the dryer and allow forced air to evaporate water or other fluids on the user's body. In one embodiment, the body dryer is sized to form a passageway that is approximately six and a half (6.5) feet in height, and four (4) feet in width.

The top and the sides of the body dryer may be constructed of any materials capable of forming a walk-through sized structure. Materials of which the top and sides can be made include but are not limited to plastics, metals, composite materials, ceramics, and the like. Preferably, the top and sides may be constructed of a material rigid enough to support internal electrical and mechanical components within them. The top and sides may be manufactured using methods known to those skilled in the art, such as injection molding, or blow molding.

In one embodiment, the housing may be constructed for outdoor use by being made of a material suitable for outdoor use. Materials suitable for outdoor use may be durable materials that are resistant to rain, winds, and the sun such as plastics, metals, concrete, composites, and the like. Moreover, when constructed for outdoor use the housing may be sealed or sealable to prevent water or debris from entering the housing and any components therein. Similarly, any external components of the body dryer may be constructed of sufficiently durable materials to withstand the elements, and may be sealed to prevent water or debris from entering them. In one embodiment of an outdoor body dryer, the body dryer may be placed substantially in proximity to a swimming pool or other swimming area such as a hot tub, lake, or ocean. Substantial proximity being intended to mean any distance such that a user, while still wet, may conveniently move from the swimming area to the body dryer and use it to dry the user's body.

In another embodiment, the housing may be constructed for indoor use. In this embodiment, the components need not be as durable or heavy-duty as the embodiment for outdoor use. Moreover, this embodiment need not be sealed to keep out the elements. As such, the housing constructed for indoor use may be of lower cost than one constructed for outdoor use. In one embodiment of an indoor body dryer, the body dryer may be placed substantially in proximity to a shower or bathtub. Substantial proximity being intended to mean any distance such that a user, while still wet, may conveniently move from the shower or bathtub to the body dryer and use it to dry the user's body before dripping excessively on a floor.

The top may form a plurality of apertures that may act as air outlets to direct air at a user's body. Further, one or both of the sides may form a plurality of apertures that may act as air outlets to direct air at a user's body.

A blower may be connected to the plurality of apertures of the body dryer. In one embodiment, the air blower may be positioned within the housing of the body dryer. In this embodiment, the blower may be encased in the top portion of the housing or one of the sides, and may bring air in through a vent in the housing. In another embodiment, the air blower may be external from the housing. The air blower may be connected to the apertures of the body dryer in any manner that provides fluid communication between the blower and the apertures. For example, by a tube, a series of tubes, ducting, or the like. In one embodiment, these tubes may be enclosed within a central aperture of the top.

In one embodiment, the blower may be a fan. In another embodiment, the blower may be a compressor. In yet another embodiment, the blower may be a centrifugal compressor. Other examples of blowers may include reciprocating compressors, axial compressors, and the like.

In another embodiment, there may be additional blowers designated to each section of the body dryer. For example, there may be a blower designated to each side of the body dryer and a blower designated to the top of the body dryer. A top blower may be connected to the plurality of apertures on the top section, and the side blowers may be connected to the plurality of apertures on their respective sides.

The blower may have a control unit capable of adjusting the attributes of the air directed by the apertures. Attributes may include but are not limited to the air's temperature, intensity, and direction of flow, source of flow, and what apertures the air exits from.

In one embodiment, the control unit may comprise a plurality of knobs to adjust the air's temperature, intensity, and direction of flow. In another embodiment, slide switches may be used to control the attributes of the air. In still another embodiment, the control unit may further comprise a plurality of push buttons to adjust the attributes of the air. Alternative control methods for the control unit may include dials, levers, voice commands, external wireless control, and the like.

In another embodiment, the control unit may comprise a digital display which indicates the current status of the attributes.

In still another embodiment, the control unit may comprise a controller capable of directing air flow to only the selected air outlets. The controller may be capable of directing air to any combination of apertures formed by the two sides and the top of the body dryer.

In yet another embodiment, there may be a separate control unit for each of a plurality of blowers. In an alternative embodiment, there may be a single control unit which is capable of controlling the plurality of blowers.

The body dryer may further include a rain gutter affixed, or integral with the top of the housing. The rain gutter may be a channel that runs along any part of an upper face of the top of the housing. In one embodiment, the rain gutter may be substantially cylindrical in shape with a longitudinal opening along the cylinder, allowing liquid to enter. The rain gutter may be affixed to the perimeter at a slight angle to allow water that collects on the top of the housing to flow down into the rain gutter and then away from the housing. This embodiment may keep water away from the electrical components of the housing, preventing the possibility of dangerous electrical shocks or damage to the electrical components.

The rain gutter may be constructed of any material capable of containing water. Materials of which the rain gutter can be made include but are not limited to plastics, metals, composite materials, ceramics, and the like. Preferably, the top and sides may be constructed of a material durable enough to withstand the erosion effects that water may cause over time.

In one embodiment, the rain gutter may lead water to any nearby area where water is desired.

In another embodiment, the rain gutter may lead water to a liquid cooling apparatus positioned near the blower that utilizes water to keep the blower from overheating.

In yet another embodiment, the rain gutter may lead water to a filter which filters the water and feeds it into a nearby swimming pool.

The body dryer may further have a dispenser capable of holding and dispensing various gels, liquids, lotions, and the like. The dispenser may be affixed to or hung from any part of the body dryer.

In one embodiment, the dispenser may be affixed to an outer surface of a side of the housing. The dispenser may include a portion that allows a fastener to pass through it and into a surface of one of the sides. In another embodiment, the dispenser may have a section that can slide onto a hook, the hook having a fastener end, which is affixed to one of the sides of the housing. The hook may be comprised of any material capable of supporting the weight of the container. Preferably, the hook may be constructed of a material that can withstand the wear and tear of water, wind, sun and other outdoor elements.

In another embodiment, the dispenser may be hung from the top of the housing. The dispenser may be attached to a hanging hook, the hanging hook having one end affixed to the top of the housing, and another end affixed to the dispenser. The hanging hook may be comprised of any material capable of supporting the weight of the dispenser. Preferably, the hanging hook may be constructed of a material that can withstand the wear and tear of water wind, sun and other outdoor elements.

In another embodiment, the dispenser may be embedded into the surface of one of the sides of the housing. The pumping mechanism may protrude from the surface of one of the sides of the housing, giving the user access to the contents of the container.

The dispenser may further have a pumping mechanism, said pumping mechanism comprising a tube situated within a container of the dispenser and a pump dispenser, and being capable of dispensing the container's contents upon depression of the pump dispenser.

In another embodiment, the container of the dispenser may be refillable. In one embodiment, the container of the dispenser may have a threaded top and a threaded cap to allow for refilling of the container. In another embodiment, the container may be removable and refillable.

The body dryer may comprise a power switch to activate the various features of the body dryer, including but not limited to the air blower, lights, radio, and heater.

In one embodiment, the power switch may be similar to a typical wall-mounted switch, said wall-mounted switch having a powered on position and a powered off position.

In another embodiment, the power switch may be a push button switch that may initiate a powered on state by depressing a button, and may be put in a powered off state by depressing the button a second time.

In another embodiment, the power switch may be a push button which is put in a powered on state by depressing a button, and remains in the powered on state for a programmed amount of time. This may allow for automatic shutdown in the case that the dryer is accidentally left on.

In another embodiment, there may be a sensor situated in the vicinity of the body dryer which is capable of detecting the presence of a user. So long as the sensor detects a person, the body dryer may remain in the powered on state. In another embodiment, the sensor may be activated by detecting movement. So long as the sensor detects movement, or for a specified period after detecting movement, the body dryer may remain in a powered on state.

In another embodiment, there may be a plurality of switches which activate the various features of the body dryer independently.

The body dryer may have a heater to heat the air that is discharged by the blower. One advantage of a heater may be to increase the drying efficiency of the body dryer.

In one embodiment, the heater may be an electric convection heater. In another embodiment, the heater may be a radiant heater. In yet another embodiment, the electric heater may be an infrared heater. In still another embodiment, the heater may be a resistance heater.

In one embodiment the heater may be connected to and controlled by the above-noted control unit, which may adjust the temperature of the air discharged from the body dryer.

The body dryer may have a light disposed on an external surface of the housing. This light could be, by example and not limitation, a fluorescent light, a neon light, an incandescent light, a halogen light, a compact fluorescent light, a high-intensity discharge light, a low-pressure sodium light, or an LED light.

In one embodiment, the light may be a colored light, such as blue, red, orange, black, green, purple, or pink, among other colors.

In a further embodiment, the light may be able to change colors amongst any of the possible colors for a light.

In yet another embodiment, the light may be programmed to turn on and off automatically in a sequence to provide a light show.

In another embodiment, the light may be rotated so that it can be pointed in a direction desired by the user.

In one embodiment, the body dryer may have a plurality of lights. The plurality lights may be directed in the same direction, providing a higher concentration of light to a particular area. The plurality of lights may also be directed in different directions, providing a larger breadth of light to different areas around the body dryer and covering a larger area. The plurality of lights may have any or all of the functions that the single light source may have.

The light source may have controls which may alter different aspects of the light, such as brightness, color, and blinking sequence, among other things. The controls may be, by example and not limitation, flip switches, sliding switches, buttons, dials, or levers.

In an embodiment designed for outdoor use, the light source or the controls may be encased in plastic or some other water-resistant material to allow for water-proofing of an electrical system providing electricity to the light source.

The body dryer may have wheels along a base of the two sides for ease of transportation. The wheels may be made of plastic, rubber, metal, or carbon fiber, among other things. In one embodiment, the wheels may further include a locking brake.

The body dryer may have a built-in stereo system. This stereo system may include, but is not limited to, speakers, an AM/FM radio, a satellite radio, a compact disc player, a cassette player, an auxiliary port, controls, and a hard drive.

In one embodiment, the stereo system may further have the capability to wirelessly stream music from other devices.

In another embodiment, the stereo system may connect, wirelessly or otherwise, to external speakers.

In another embodiment, the stereo system may be encased in plastic or some other water-resistant material to allow for water-proofing of an electrical system providing electrical power to the stereo system.

The controls of the stereo system may control different aspects of the stereo system, such as volume, music source, external speaker connection, or song choice, among other things. The controls may be, by example and not limitation, flip switches, sliding switches, buttons, dials, or levers.

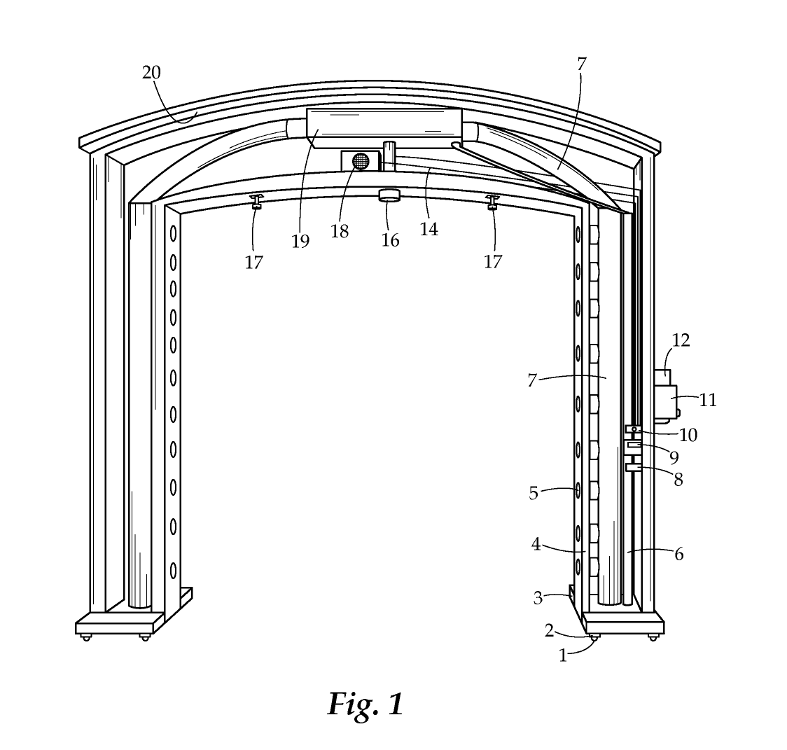

Turning now to FIG. 1, one embodiment of a front cutaway view of the body dryer is shown. The dryer housing is shown as having a substantially inverted U shape. At the bottom of each side 4 of the body dryer is a base 3. A plurality of wheels 1 are shown attached to the base 3. A locking brake 2 is connected to each wheel 1 such that the body dryer may be secured in place. On each side 4 are a plurality of apertures 5 configured as air outlets to direct air at a human body positioned within the passageway formed by the housing. The apertures 5 are positioned from the base 3 of each side 4 to the top of the housing, thereby providing air flow from a user's feet to a user's head. A top air flow aperture 16 is located at the top of the body dryer to provide direct air flow at the head and hair of a user. Air is provided by a blower 19 that forces air through an air flow duct 7 that is in fluid communication with each aperture 5. The blower 19 brings air in through an air inlet (not shown), and expels it into the air flow duct 7 which in turn directs air out through the apertures 5. On the top of the housing, a rain gutter 20 may be provided to move rain off the top and away from the body dryer.

An electrical conduit 6 may run along the side 4 to provide electrical power to the blower 19 and any other electrical components on the body dryer. Activation of the body dryer may be controlled by a power switch 8. The power switch 8 activates the blower 19 which in turn forces air through the ducts 7 and out of the apertures 5.

The body dryer may have a number of additional optional features. For example, FIG. 1 shows a stereo system 9 incorporated into the body dryer. The stereo system 9 is connected to a speaker 18 to allow users to listen to music or a talk show while drying, and even when the dryer is deactivated. Electrical power is provided to the radio by the radio power supply 14.

A set of lights 17 are attached to the top of the housing. These lights 17 may be controlled by a power switch 10, which is in electronic communication with the lights 17.

A refillable lotion dispenser 11 is positioned on the outer surface of one of the sides 4. The dispenser 11 has one or a plurality of bottles 12 that contain lotions and the like that may be desirable to apply to a user's body after drying.

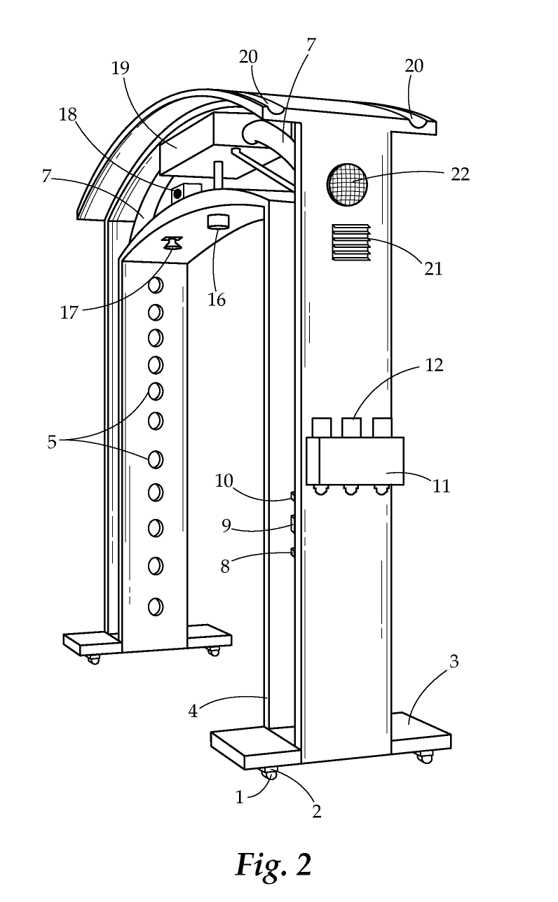

FIG. 2 shows a perspective view of a partial cutaway of one embodiment of the body dryer. The dryer housing is shown as having a substantially inverted U shape. At the bottom of each side 4 of the body dryer is a base 3. A plurality of wheels 1 are shown attached to the base 3. A locking brake 2 is connected to each wheel 1 such that the body dryer may be secured in place. On each side 4 are a plurality of apertures 5 configured as air outlets to direct air at a human body positioned within the passageway formed by the housing. The apertures 5 are positioned from the base 3 of each side 4 to the top of the housing, thereby providing air flow from a user's feet to a user's head. A top air flow aperture 16 is located at the top of the body dryer to provide direct air flow at the head and hair of a user. Air is provided by a blower 19 that forces air through an air flow duct 7 that is in fluid communication with each aperture 5. The blower 19 brings air in through an air inlet 21, and expels it into the air flow duct 7 which in turn directs air out through the apertures 5. On the top of the housing, a rain gutter 20 may be provided to move rain off the top and away from the body dryer.

Activation of the body dryer may be controlled by a power switch 8. The power switch 8 activates the blower 19 which in turn forces air through the ducts 7 and out of the apertures 5.

The body dryer may have a number of additional optional features. For example, FIG. 2 shows a stereo system 9 incorporated into the body dryer. The stereo system 9 is connected to a speaker 18 and speaker 22 to allow users to listen to music or a talk show while drying, and even when the dryer is deactivated.

A light 17 is attached to the top of the housing. The light 17 may be controlled by a power switch 10, which is in electronic communication with the lights 17.

A refillable lotion dispenser 11 is positioned on the outer surface of one of the sides 4. The dispenser 11 has one or a plurality of bottles 12 that contain lotions and the like that may be desirable to apply to a user's body after drying.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A human body dryer comprising:
a housing having a top and two sides, the housing forming a passageway through which a user may pass;
an aperture formed by the housing, and opening into the passageway; and
a blower in fluid communication with the aperture, the blower constructed and arranged to provide a quantity of air directed into the passageway by the aperture.

2. The human body dryer of claim 1 further comprising a plurality of apertures formed by the housing constructed and arranged to direct the quantity of air into the passageway.

3. The human body dryer of claim 1 further comprising a plurality of apertures formed by at least one of the top and the two sides of the housing.

4. The human body dryer of claim 2 further comprising a heater disposed between the blower and the plurality of apertures, and constructed and arranged to provide heat to the quantity of air.

5. The human body dryer of claim 2 further comprising:
a base attached to a bottom portion of each of the two sides of the housing, the bases forming an open bottom of the housing; and
a wheel attached to the base of each side.

6. The human body dryer of claim 2 wherein the housing forms a substantially inverted ‘u’ shape.

7. The human body dryer of claim 1 wherein the two sides of the housing form an open bottom.

8. The human body dryer of claim 2 wherein the blower is mounted within the housing.

9. The human body dryer of claim 2 wherein the housing is weather resistant and constructed of a material suitable for outdoor use.

10. The human body dryer of claim 2 further comprising a built in stereo system having a radio receiver and an external speaker, the external speaker in electronic communication with the radio receiver.

11. The human body dryer of claim 2 further comprising a dispenser on an outer surface of the housing.

12. The human body dryer of claim 2 further comprising a control unit in communication with the blower and the plurality of apertures and constructed and arranged to adjust an air flow attribute through the plurality of apertures, the control unit being positioned on an outer surface of the housing.

13. The human body dryer of claim 2 further comprising a light source secured to an outer surface of the housing.

14. The human body dryer of claim 9 further comprising a gutter formed on the top of the housing.

15. The human body dryer of claim 8 further comprising an air inlet vent providing fluid communication between an outside of the housing and an inlet of the blower.

16. A human body drying apparatus for outdoor use comprising:
a housing having a top and two sides, the housing forming a passageway through which a user may pass, the housing being positioned substantially in proximity to a swimming area, the housing being configured to be weather resistant for outdoor use;
an aperture formed by the housing and opening into the passageway; and
a blower, in fluid communication with the aperture, the blower constructed and arranged to provide a quantity of air directed into the passageway by the aperture, the blower being sized to provide a sufficient flow of air such that a human body may be substantially dried after being in the swimming pool.

17. The human body drying apparatus for outdoor use of claim 16 further comprising:
a plurality of apertures formed by the housing; and
a heater disposed between the blower and the plurality of apertures, constructed and arranged to provide heat to the quantity of air.

18. The human body drying apparatus for outdoor use of claim 17 wherein the blower is mounted within the housing.

19. A human body drying apparatus for indoor use comprising:
a housing having a top and two sides, the housing forming a passageway through which a user may pass, the housing being positioned substantially in proximity to a shower or bathtub;
an aperture formed by the housing and opening into the passageway; and
a blower, in fluid communication with the aperture, the blower constructed and arranged to provide the quantity of air directed into the passageway by the aperture, the blower being sized to provide a sufficient flow of air such that a human body may be substantially dried after being in the swimming pool.

20. The human body drying apparatus for indoor use of claim 19 further comprising:
a plurality of apertures formed by at least one of the top and the two sides of the housing;
a heater disposed between the blower and the plurality of apertures, constructed and arranged to provide heat to the quantity of air; and
wherein the blower is mounted within the housing.
